(19) United States
(12) Patent Application Publication
(10) Pub. No.: US 2007/0074180 A1
(43) Pub. Date: Mar. 29, 2007

(54) Systems, Methods and Apparatus for Procedure Development and Verification

(75) Inventors: Michael G. Hinchey, Bowie, MD (US); James L. Rash, Davidsonville, MD (US); Christopher A. Rouff, Beltsville, MD (US); Denis Gracanin, Blacksburg, VA (US)

Correspondence Address: NASA GODDARD SPACE FLIGHT CENTER, 8800 GREENBELT ROAD, MAIL CODE 140.1, GREENBELT, MD, 20771, US

(73) Assignee: NASA HQ'S, Washington, DC (US)

(21) Appl. No.: 11/461,669

(22) Filed: Aug. 1, 2006

Related U.S. Application Data
(63) Continuation-in-part of application No. 11/203,590, filed on Aug. 12, 2005.
(63) Continuation-in-part of application No. 10/789,028, filed on Feb. 25, 2004.
(60) Provisional application No. 60/706,105, filed on Aug. 1, 2005.
(60) Provisional application No. 60/603,521, filed on Aug. 13, 2004.
(60) Provisional application No. 60/533,376, filed on Dec. 22, 2003.

(51) Int. Cl. G06F 9/45

(52) U.S. Cl. 717/136; 703/2

(57) ABSTRACT

Systems, methods and apparatus are provided through which, in some embodiments, a script is derived from scenarios, the script is analyzed, and flaws in the script are corrected. The systems, methods and apparatus may include inferring an equivalent formal model from procedures described in natural language (such as English), as scenarios, use cases, or a representation in one of a plethora of graphical notations Such a model can be analyzed for contradictions, conflicts, use of resources before the resources are available, competition for resources, and so forth. From such a formal model, code can be automatically generated in a variety of notations. This may include high level programming languages, machine languages, and scripting languages. The approach improves the resulting code, which may be provably equivalent to the procedures described at the outset. In “reverse engineering” mode, the systems, methods and apparatus may be used to retrieve meaningful descriptions of existing scripts that implement complex procedures, which improves documentation of scripts.

### RELATED APPLICATIONS

This application claims the benefit of U.S. Provisional Application Ser. No. 60/706,105 filed Aug. 1, 2005 under 35 U.S.C. 119(e). This application is a continuation-in-part of co-pending U.S. application Ser. No. 11/203,590 filed Aug. 12, 2005 entitled “Systems, Methods & Apparatus For Implementation Of Formal Specifications Derived From Informal Requirements,” which claims the benefit of U.S. Provisional Application Ser. No. 60/603,521 filed Aug. 13, 2004 under 35 U.S.C. 119(e), which is a continuation-in-part of co-pending U.S. application Ser. No. 10/789,028 filed Feb. 25, 2004 entitled “System and Method for Deriving a Process-Based Specification,” which claims the benefit of U.S. Provisional Application Ser. No. 60/533,376 filed Dec. 22, 2003.

### ORIGIN OF THE INVENTION

The invention described herein was made by employees of the United States Government and may be manufactured and used by or for the Government of the United States of America for governmental purposes without the payment of any royalties thereon or therefor.

### FIELD OF THE INVENTION

This invention relates generally to software development processes and more particularly to validating a system implemented from requirements expressed in natural language or a variety of graphical notations.

### BACKGROUND OF THE INVENTION

High dependability and reliability is a goal of all computer and software systems. Complex systems in general cannot attain high dependability without addressing crucial remaining open issues of software dependability. The need for ultra-high dependable systems increases continually, along with a corresponding increasing need to ensure correctness in system development. Correctness exists where the implemented system is equivalent to the requirements, and where this equivalence can be mathematically proven.

The development of a system may begin with the development of a requirements specification, such as a formal specification or an informal specification. A formal specification might be encoded in a high-level language, whereas requirements in the form of an informal specification can be expressed in restricted natural language, “if-then” rules, graphical notations, English language, programming language representations, flowcharts, scenarios or even semi-formal notations such as unified modeling language (UML).

A scenario can be defined as a natural language text (or a combination of any, e.g. graphical, representations of sequential steps or events) that describes the software's actions in response to incoming data and the internal goals of the software. Some scenarios can also describe communication protocols between systems and between the components within the systems. Also, some scenarios can be known as UML use-cases. In some embodiments, a scenario describes one or more potential executions of a system, describing what happens in a particular situation, and what range of behaviors is expected from or omitted by the system under various conditions.

Natural language scenarios are usually constructed in terms of individual scenarios written in a structured natural language. Different scenarios can be written by different stakeholders of the system, corresponding to the different views of the stakeholders of how the system will perform, including alternative views corresponding to higher or lower levels of abstraction. Natural language scenarios can be generated by a user with or without mechanical or computer aid. The set of natural language scenarios provides the descriptions of actions that occur as the software executes. Some of these actions may be explicit and required, while others can be due to errors arising, or as a result of adapting to changing conditions as the system executes.

For example, if the system involves commanding space satellites, scenarios for that system can include sending commands to the satellites and processing data received in response to the commands. Natural language scenarios might be specific to the technology or application domain to which the natural language scenarios are applied. A fully automated general purpose approach covering all domains is technically prohibitive to implement in a way that is both complete and consistent. To ensure consistency, the domain of application might be purpose-specific. For example, scenarios for satellite systems might not be applicable as scenarios for systems that manufacture agricultural chemicals.

After completion of an informal specification that represents domain knowledge, the system is developed. A formal specification is not necessarily used by the developer in the development of a system.

In the development of some systems, computer readable code may be generated. The generated code is typically encoded in a computer language, such as a high-level computer language. Examples of such languages include Java, C, C Language Integrated Production System (CLIPS), and Prolog.

One step in creating a system with high dependability and reliability can be verification and validation that the executable system accurately reflects the requirements. Validation of the generated code is sometimes performed through the use of a domain simulator, a very elaborate and costly approach that is computationally intensive. This process of validation via simulation rarely results in an unambiguous result and rarely results in uncontested results among systems analysts. In some examples, a system is validated through parallel mode, shadow mode operations with a human operated system. This approach can be very expensive and exhibit severely limited effectiveness. In some complex systems, this approach leaves vast parts of possible execution paths forever unexplored and unverified.

During the life cycle of a system, requirements typically evolve. Manual change to the system creates a risk of introducing new errors and necessitates retesting and revalidation, which can greatly increase the cost of the system. Often, needed changes are not made due to the cost of verifying/validating consequential changes in the rest of the system. Sometimes, changes are simply made in the code and not reflected in the specification or design, due to the cost or due to the fact that those who generated the original specification or design are no longer available.

Procedures, considered as the essential steps or actions to achieve a result, are used for the assembly of materials in factories, for servicing of spacecraft (whether by astronauts, robots, or a combination), for business operation, and for experiments in a laboratory, to name but a few. Procedures can be very complex, involving many interactions, may involve many actions happening in parallel, and may be subject to significant constraints such as the ordering in which activities must happen, the availability of resources, and so forth. In many complex procedures, it is quite common for human error to result in the entire procedure needing to be repeated ab initio. In some cases, such as servicing a spacecraft, it may not be possible to recover from some of the more serious errors that may occur. Typically, such procedures are implemented in scripting languages, which are not as “solid” as programming languages, and where errors may go undetected.

Conventional methods for verifying procedures, scripts, sequences of actions, and the like, may offer limited capabilities and have limited effectiveness. Having no mathematical basis, the conventional methods cannot produce provable correctness for non trivial procedures/scripts. Conventional methods often support no more than actual testing, which for non-trivial systems leaves uncertainty about possible remaining flaws, because complete testing of non-trivial systems is impossible by definition. In any case, the cost of completely testing systems quickly becomes prohibitively expensive as complexity increases.

Furthermore, many scripts are not properly documented, which limits the effective implementation and use of the scripts.

For the reasons stated above, and for other reasons stated below which will become apparent to those skilled in the art upon reading and understanding the present specification, there is a need in the art to reduce errors in scripts and improve documentation of scripts.

### BRIEF DESCRIPTION OF THE INVENTION

The above-mentioned shortcomings, disadvantages and problems are addressed herein, which will be understood by reading and studying the following discussion.

Systems, methods and apparatus described herein may provide automated analysis, validation, verification, and generation of complex procedures, often implemented as scripts in a scripting language. The systems, methods and apparatus may include inferring an equivalent formal model from procedures described in natural language (such as English), as scenarios, use cases, or a representation in one of a plethora of graphical notations (as long as the input can be parsed, there is little constraint on the representation). Such a model can be analyzed for contradictions, conflicts, use of resources before the resources are available, competition for resources, and so forth. From such a formal model, code can be automatically generated in a variety of notations. This may include high level programming languages, machine languages, and scripting languages. The approach improves the resulting code, which may be provably equivalent to the procedures described at the outset. In “reverse engineering” mode, the systems, methods and apparatus may be used to retrieve meaningful descriptions (in English, use cases, graphical notations, or whatever input notations are supported) of existing scripts that implement complex procedures, which may solve the need in the prior art for improved documentation of scripts. Moreover, two or more procedures or scripts may be “reversed” to appropriate formal models, the models may be combined, and the resulting combination checked for conflicts. Then, the combined, error-free model may be used to generate a new (single) procedure/script that combines the functionality of the original separate procedures/scripts, and may be more likely to be correct.

In one embodiment, systems, methods and apparatus are provided through which scenarios may be translated without human intervention into a formal specification. In some embodiments, the formal specification can be translated to a script or other set of complex procedures. In some embodiments, the formal specification may be analyzed for errors, which can reduce errors in the formal specification. In some embodiments, the formal specification may be translated back to an informal specification expressed in natural language or a plurality of graphical notations. The script or complex set of procedures can be designed for the assembly and maintenance of devices (whether by human or robots), for business operation, or for experimentation in a laboratory (such as might be used by the bioinformatics community). Other applications of the script or complex set of procedures will be apparent to one skilled in the art.

In another embodiment, a system may include an inference engine and a translator, the translator being operable to receive scenarios and to generate in reference to an inference engine, a formal specification. The system may also include an analyzer operable to perform model verification/checking and determine existence of omissions, deadlock, livelock, and race conditions or other problems and inconsistencies in either the formal specification or the script.

In yet another embodiment, a method may include translating requirements expressed informally in natural language or a plurality of graphical notations to a formal specification or script, and analyzing the formal specification or script.

Systems, clients, servers, methods, and computer-readable media of varying scope are described herein. In addition to the embodiments and advantages described in this summary, further embodiments and advantages will become apparent by reference to the drawings and by reading the detailed description that follows.

### BRIEF DESCRIPTION OF THE DRAWINGS

FIG. 1 is a block diagram that provides an overview of a system to generate a high-level computer source code program from an informal specification, according to an embodiment of the invention;

FIG. 2 is a block diagram that provides an overview of a system to engineer a script or procedure from scenarios, according to an embodiment of the invention;

FIG. 3 is a flowchart of a method to generate an executable system from an informal specification, according to an embodiment;

FIG. 4 is a flowchart of a method to translate mechanically each of a plurality of requirements of the informal specification to a plurality of process-based specification segments, according to an embodiment;

FIG. 5 is a flowchart of a method to verify the syntax of a set of scenarios, translate the set of scenarios to a formal specification, verify the consistency of the formal specification, and verify the absence of other problems, according to an embodiment;

FIG. 6 is a flowchart of a method to validate/update scenarios of a system, according to an embodiment;

FIG. 7 is a flowchart of a method to translate each of a plurality of requirements of the domain knowledge to a plurality of formal specification segments, and formally compose the plurality of formal specification segments into a single equivalent specification, and translate the single formal specification into a script, according to an embodiment;

FIG. 8 is a flowchart of a method to generate a formal specification from scenarios, according to an embodiment;

FIG. 9 is a block diagram of a hardware and operating environment in which different embodiments can be practiced according to an embodiment;

FIG. 10 is a block diagram of a particular Communicating Sequential Process (CSP) implementation of an apparatus to generate a high-level computer source code program from an informal specification, according to an embodiment;

FIG. 11 is a block diagram of a hardware and operating environment in which a particular CSP implementation of FIG. 10 is implemented, according to an embodiment;

FIG. 12 is a block diagram of a particular implementation of an apparatus capable of translating scenarios to a formal specification, optionally analyze the formal specification and translate the formal specification to a script and reverse engineer (translate) a script into a formal specification, and optionally analyze the formal specification, according to an embodiment; and

FIG. 13 is a block diagram of a hardware and operating environment in which components of FIG. 12 can be implemented, according to an embodiment.

### DETAILED DESCRIPTION OF THE INVENTION

In the following detailed description, reference is made to the accompanying drawings that form a part hereof, and in which is shown, by way of illustration, specific embodiments which can be practiced. These embodiments are described in sufficient detail to enable those skilled in the art to practice the embodiments, and it is to be understood that other embodiments can be utilized and that logical, mechanical, electrical and other changes can be made without departing from the scope of the embodiments. The following detailed description is, therefore, not to be taken in a limiting sense.

The detailed description is divided into six sections. In the first section, embodiments of a system level overview are described. In the second section, embodiments of methods are described. In the third section, embodiments of the hardware and the operating environment, in conjunction with which embodiments can be practiced, is described. In the fourth section, particular CSP implementations of embodiments are described. In the fifth section, particular script implementations of embodiments are described. Finally, in the sixth section, a conclusion of the detailed description is provided.

### SYSTEM LEVEL OVERVIEW

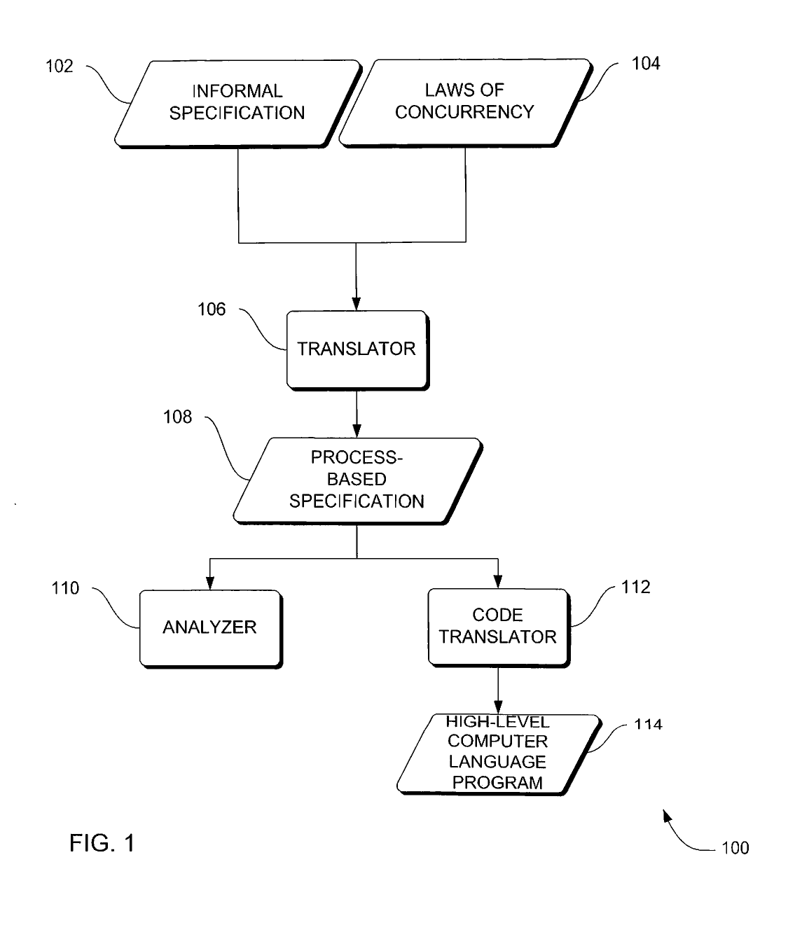

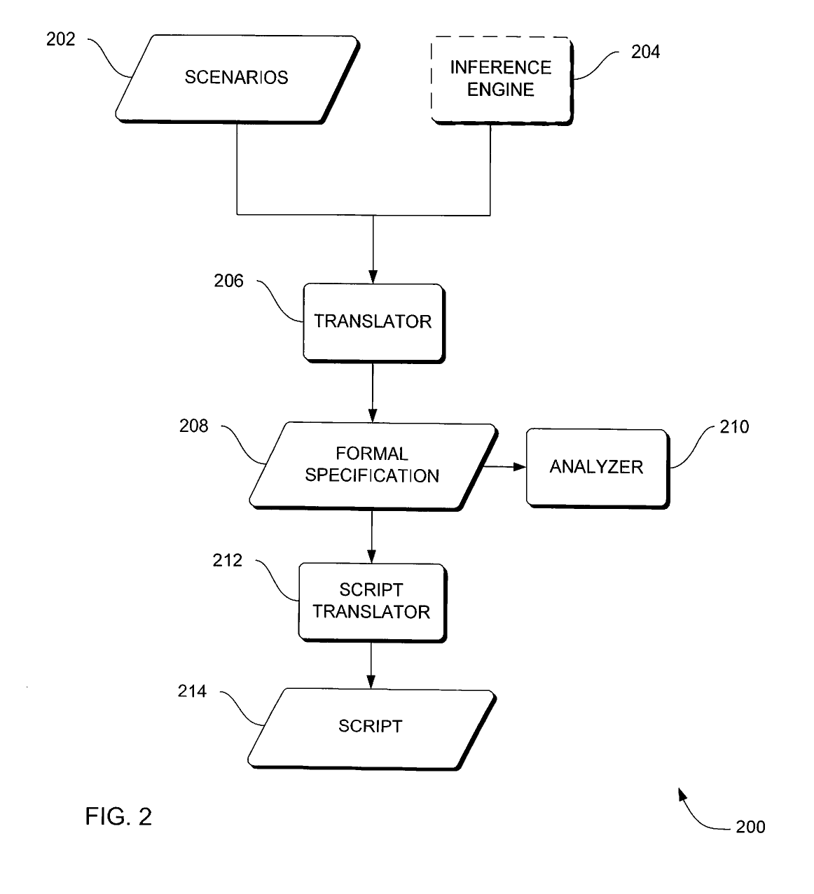

FIG. 1 is a block diagram that provides an overview of a system 100 to generate a high-level computer source code program from an informal specification, according to an embodiment. FIG. 2 is a block diagram that provides an overview of a system 200 to generate a formal specification and an implementation from descriptions of a system, according to an embodiment.

System 100 may solve the need in the art for an automated, generally applicable way to produce a system that can be a provably correct implementation of an informal design specification that does not require, in applying the system to any particular problem or application, the use of a theorem-prover.

System 100 may be a software development system that includes a data flow and processing points for the data. System 100 may be representative of (i) computer applications and electrical engineering applications such as chip design and other electrical circuit design, (ii) business management applications in areas such as workflow analysis, (iii) artificial intelligence applications in areas such as knowledge-based systems and agent-based systems, (iv) highly parallel and highly-distributed applications involving computer command and control and computer-based monitoring, and (v) any other area involving process, sequence or algorithm design. According to the disclosed embodiments, system 100 may mechanically convert different types of specifications (either natural language scenarios or descriptions which are effectively pre-processed scenarios) into process-based formal specifications on which model checking and other mathematics-based verifications can be performed, and then optionally can convert the formal specification into code.

System 100 may include an informal specification 102 having a plurality of rules or requirements. The informal specification can be expressed in restricted natural language, graphical notations, English language, programming language representations, scenarios or even using semi-formal notations such as unified modeling language (UML) use cases. One skilled in the art will recognize that other languages and graphic indicators may exist that fall within the scope of this invention.

One scenario may be natural language text (or a combination of any (possibly graphical) representations of sequential steps or events) that describes the software's actions in response to incoming data and the internal goals of the software. Scenarios also may describe communication protocols between systems and between the components within the systems. Scenarios also may be known as use-cases. A scenario describes one or more potential executions of a system, describing what happens in a particular situation, and what range of behaviors is expected from or omitted by the system under various conditions.

System 100 may also include a set of laws of concurrency 104. Laws of concurrency 104 are rules detailing equivalences between sets of processes combined in various ways, and/or relating process-based descriptions of systems or system components to equivalent sets of traces. An example of the laws of concurrency 104 is given in “Concurrent Systems: Formal Development in CS” by M.G. Hinchey, an S.A. Jarvis, McGraw-Hill International Series in Software Engineering, New York and London, 1995, which is herein incorporated by reference in its entirety. Laws of concurrency 104 may be expressed in any suitable language for describing concurrency. These languages may include, but are not limited to, CSP (Communicating Sequential Processes), CCS (Calculus of Communicating Systems) and variants of these languages.

The informal specification 102 and a set of laws of concurrency 104 can be received by a mechanical translator 106. The plurality of rules or requirements of the informal specification 102 may be translated mechanically to a process-based specification 108 or other formal specification language representation. The mechanical embodiment means that no manual intervention in the translation is provided. In some embodiments, the process-based specification 108 may be an intermediate notation or language of sequential process algebra such as Hoare's language of Communicating Sequential Processes (CSP).

The process-based specification 108 may be mathematically and provably equivalent to the informal specification 102. Mathematically equivalent does not necessarily mean mathematically equal. Mathematical equivalence of A and B means that A implies B and B implies A. Note that applying the laws of concurrency 104 to the process-based specification 108 would allow for the retrieval of a trace-based specification that may be equivalent to the informal specification 102. Note that the process-based specification may be mathematically equivalent to rather than necessarily equal to the original informal specification 108. This embodiment indicates the process may be reversed, allowing for reverse engineering of existing systems, or for iterative development of more complex systems.

In some embodiments, the system may include an analyzer 110 to determine various properties such as existence of omissions, deadlock, livelock, and race conditions in the process-based specification 108.

System 100 may also include a code translator 112 to translate the plurality of process-based specification segments 108 to a set of instructions in a high-level computer language program 114, such as the Java language.

System 100 may be operational for a wide variety of informal specification languages and applications, thus system 100 can be generally applicable. Such applications will be apparent to one skilled in the art and may include distributed software systems, sensor networks, robot operation, complex scripts for spacecraft integration and testing, chemical plant operation and control, and autonomous systems.

System 100 can provide mechanical regeneration of the executable system when requirements dictate a change in the high level specification. In system 100, all that may be required to update the generated application may be a change in the informal specification 102, and then the changes and validation can ripple through in a mechanical process when system 100 operates. This also can allow the possibility of cost effectively developing competing designs for a product and implementing each to determine the best one.

Most notably, in some embodiments, system 100 does not include a theorem-prover to infer the process-based specification segments from the informal specification. However, the plurality of process-based specification segments 108 may be provably correct implementations of the informal specification 102, provided the developer of an instance of system 100 has properly used a theorem-prover (not shown) to prove that the mechanical translator 106 correctly translates informal specifications into formal specifications.

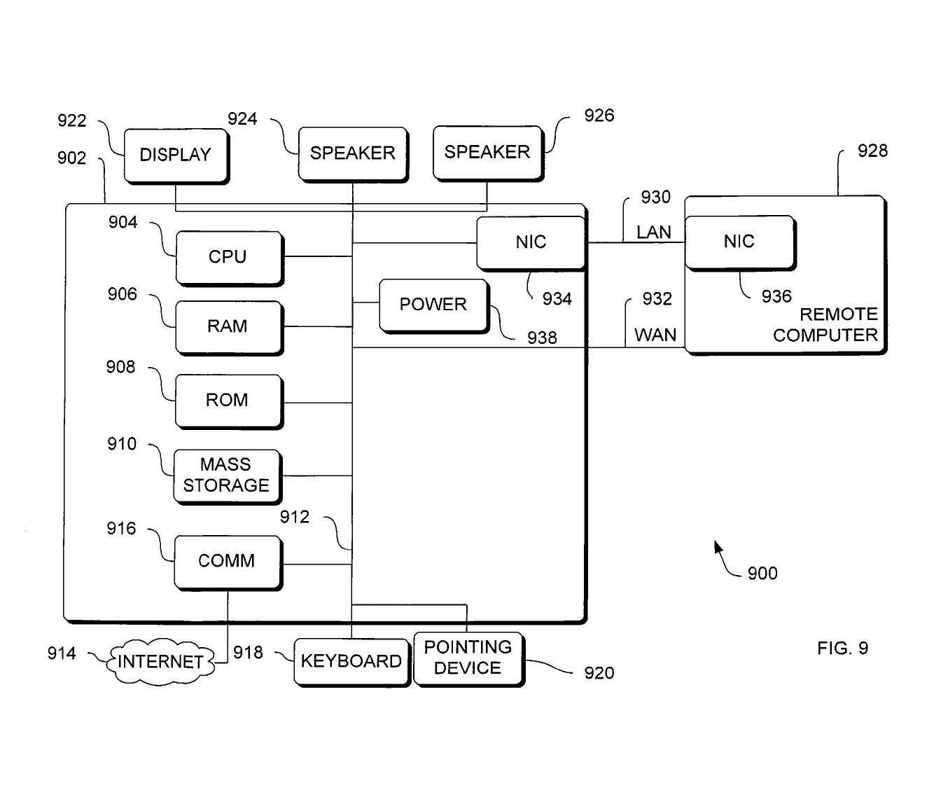

Some embodiments of system 100 operate in a multi-processing, multi-threaded operating environment on a computer, such as computer 902 in FIG. 9. While the system 100 is not limited to any particular informal specification 102, plurality of rules or requirements, set of laws of concurrency 104, mechanical translator 106, process-based specification 108, analyzer 110, code translator 112 and high-level computer language program 114, for sake of clarity a simplified informal specification 102, plurality of rules or requirements, set of laws of concurrency 104, mechanical translator 106, process-based specification 108, analyzer 110, code translator 112, and high-level computer language program 114 are illustrated.

System 100 may relate to the field of chemical or biological process design or mechanical system design, and, generally to any field where the behaviors exhibited by a process to be designed can be described by a set of scenarios expressed in natural language, or some appropriate graphical notation or textual notation.

FIG. 2 is a block diagram that provides an overview of a system 200 to engineer a script or procedure from scenarios, according to an embodiment. System 200 may solve the need in the art for an automated, generally applicable way to verify that an implemented script is a provably correct implementation of a set of scenarios.

One embodiment of the system 200 may be a software development system that includes a data flow and processing points for the data. According to the disclosed embodiments, system 200 may convert scenarios into a script on which model checking and other mathematics-based verifications can then be performed.

The system 200 can include a plurality of scenarios 202. The scenarios 202 can be written in a particular syntax, such as constrained natural language or graphical representations. The scenarios 202 can embody software applications, although one skilled in the art will recognize that other systems fall within the purview of this invention.

In one embodiment, the scenarios 202 may be received by a translator 206. The optional inference engine 204 might be referenced by the translator 206 when the scenarios 202 are translated by the translator 206 into a formal specification 208. Subsequently, the formal specification 208 can be translated by script translator 212 into a script 214 in some appropriate scripting language. In some embodiments no manual intervention in the translation is provided. Those skilled in the art will readily understand that other appropriate notations and/or languages exist that are within the scope of this invention.

In some embodiments, system 200 can include an analyzer 210 to determine various properties of the formal specification, such as the existence of omissions, deadlock, livelock, and race conditions, as well as other conditions, in the formal specification 208, although one skilled in the art will recognize that other additional properties can be determined by the analyzer 210. The analyzer 210 may solve the need in the prior art to reduce errors.

The terms “scripts” and “procedures” can be used interchangeably. Scripts can encompass not only instructions written programming languages (such as Python) but also languages for physical (electromechanical) devices and even in constrained natural language instructions or steps or checklists to be carried out by human beings such as, but not limited to, an astronaut.

Scripting languages are computer programming languages initially used only for simple, repeated actions. The name “scripting languages” comes from a written script such as a screenplay, where dialog is repeated verbatim for every performance. Early script languages were often called batch languages or job control languages. A script is typically interpreted rather than compiled, but not always. Scripting languages may also be known as scripting programming languages or script languages.

Many such languages can be quite sophisticated and have been used to write elaborate programs, which are often still called scripts even though the applications of scripts are well beyond automating simple computer tasks. A script language can be found at almost every level of a computer system. Besides being found at the level of the operating system, scripting languages appear in computer games, web applications, word processing documents, network software and more. Scripting languages favor rapid development over efficiency of execution; scripting languages are often implemented with interpreters rather than compilers; and scripting languages are effective in communication with program components written in other languages.

Many scripting languages emerged as tools for executing one-off tasks, particularly in system administration. One way of looking at scripts is as “glue” that puts several components together; thus scripts are widely used for creating graphical user interfaces or executing a series of commands that might otherwise have to be entered interactively through keyboard at the command prompt. The operating system usually offers some type of scripting language by default, widely known as a shell script language.

Scripts are typically stored only in their plain text form (as ASCII) and interpreted, or compiled each time prior to being invoked.

Some scripting languages are designed for a specific domain, but often it is possible to write more general programs in that language. In many large-scale projects, a scripting language and a lower level programming language are used together, each lending its particular strengths to solve specific problems. Scripting languages are often designed for interactive use, having many commands that can execute individually, and often have very high level operations (for example, in the classic UNIX shell, most operations are programs).

Such high level commands simplify the process of writing code. Programming features such as automatic memory management and bounds checking can be taken for granted. In a ‘lower level’ or non-scripting language, managing memory and variables and creating data structures tends to consume more programmer effort and lines of code to complete a given task. In some situations this is well worth it for the resulting fine-grained control. The scripter typically has less flexibility to optimize a program for speed or to conserve memory.

For the reasons noted above, it is usually faster to program in a scripting language, and script files are typically much smaller than programs with equivalent functionality in conventional programming languages such as C.

Scripting languages may fall into eight primary categories: Job control languages and shells, macro languages, application-specific languages, web programming languages, text processing languages, general-purpose dynamic languages, extension/embeddable languages, and extension/embeddable languages.

In regards to job control scripting languages and shells, a major class of scripting languages has grown out of the automation of job control—starting and controlling the behavior of system programs. Many of these languages' interpreters double as command-line interfaces, such as the Unix shell or the MS-DOS COMMAND.COM. Others, such as AppleScript, add scripting capability to computing environments lacking a command-line interface. Examples of job control scripting languages and shells include AppleScript, ARexx (Amiga Rexx), bash, csh, DCL, 4NT, JCL, ksh, MS-DOS batch, Windows PowerShell, REXX, sh, and Winbatch

In regards to macro scripting languages, with the advent of Graphical user interfaces, a specialized kind of scripting language for controlling a computer evolved. These languages, usually called Macro languages, interact with the same graphic windows, menus, buttons and such that a person does. Macro language scripts are typically used to automate repetitive actions or configure a standard state. Macro language scripts can be used to control any application running on a GUI-based computer, but in practice the support for such languages depends on the application and operating system. Examples of macro scripting languages include AutoHotkey, AutoIt, and Expect.

In regards to application-specific scripting languages, many large application programs include an idiomatic scripting language tailored to the needs of the application user. Likewise, many computer game systems use a custom scripting language to express the programmed actions of non-player characters and the game environment. Languages of this sort are designed for a single application and, while application-specific scripting languages can superficially resemble a specific general-purpose language (e.g. QuakeC, modeled after C) application-specific scripting languages have custom features which distinguish the application-specific scripting languages. Examples of application-specific scripting languages include, Action Code Script, ActionScript, AutoLISP, BlobbieScript [1], Emacs Lisp, HyperTalk, IRC script, Lingo, Cana Embedded Language, mIRC script, NWscript, QuakeC, UnrealScript, Visual Basic for Applications, VBScript, and ZZT-oop.

In regards to web programming scripting languages, an important type of application-specific scripting language is one used to provide custom functionality to internet web pages. Web programming scripting languages are specialized for internet communication and use web browsers for their user interface. However, most modern web programming scripting languages are powerful enough for general-purpose programming. Examples of web programming scripting language include ColdFusion (Application Server), Lasso, Miva, and SMX.

In regards to text processing scripting languages, the processing of text-based records is one of the oldest uses of scripting languages. Many text processing languages, such as Unix's AWK and, later, PERL, were originally designed to aid system administrators in automating tasks that involved Unix text-based configuration and log files. PERL is a special case—originally intended as a report-generation language, it has grown into a full-fledged applications language in its own right. Examples of text processing scripting languages include AWK, PERL, sed and XSLT.

In regards to general-purpose dynamic scripting languages, some languages, such as PERL, began as scripting languages but developed into programming languages suitable for broader purposes. Other similar languages—frequently interpreted, memory-managed, dynamic—have been described as “scripting languages” for these similarities, even if general-purpose dynamic scripting languages are more commonly used for applications programming. Examples of general-purpose dynamic scripting languages include APL, Dylan, Groovy, MUMPS (M), newLISP, PERL, PHP, Python, Ruby, Scheme, Smalltalk, SuperCard, and Tool command language (TCL). TCL was created as an extension language but has come to be used more frequently as a general purpose language in roles similar to Python, PERL, and Ruby.

In regards to extension/embeddable languages, a small number of languages have been designed for the purpose of replacing application-specific scripting languages by being embeddable in application programs. The application programmer (working in C or another systems language) includes “hooks” where the scripting language can control the application. These languages serve the same purpose as application-specific extension languages, but with the advantage of allowing some transfer of skills from application to application. Examples of extension/embeddable script languages include Ch (C/C++interpreter), ECMAScript a.k.a. DMDScript, JavaScript, JScript, GameMonkeyScript, Guile, ICI, Squirrel, Lua, TCT, and REALbasic Script (RBScript).

JavaScript began as and primarily still is a language for scripting inside of web browsers, however, the standardization of the language as ECMAScript has made JavaScript widely adopted as a general purpose embeddable language.

Other scripting languages include BeanShell (scripting for Java), CobolScript, Escapade (server side scripting), Euphoria, F-Script, Ferite, Groovy, Gui4Cli, To, KiXtart, Mondrian, Object REXX, Pike, Pliant, REBOL, ScriptBasic, Shorthand Language, Simkin, Sleep, StepTalk, and Visual DialogScript.

In some embodiments, the script 214 can be mathematically and provably equivalent to the scenarios 202. Mathematically equivalent does not necessarily mean mathematically equal. Mathematical equivalence of A and B means that A implies B and B implies A. Note that the script 214 of some embodiments can be mathematically equivalent to, rather than necessarily equal to, the scenarios 202.

In some embodiments, the formal specification 208 can be a process-based specification, such as process algebra encoded notation. The process algebra encoded notation is a mathematically notated form. This embodiment may satisfy the need in the art for an automated, mathematics-based process for requirements validation that does not require large computational facilities.

In some embodiments, the scenarios 202 of system 200 can specify allowed situations, events and/or results of a software system. In that sense, the scenarios 202 can provide a very abstract specification of the software system.

Some embodiments of system 200 can be operational for a wide variety of rules, computer instructions, computer languages and applications; thus, system 200 may be generally applicable. Such applications can include, without limitation, space satellite control systems, distributed software systems, sensor networks, robot operations, complex scripts for spacecraft integration and testing, chemical plant operation and control, autonomous systems, electrical engineering applications such as chip design and other electrical circuit design, business management applications in areas such as workflow analysis, artificial intelligence applications in areas such as knowledge-based systems and agent-based systems, highly parallel and highly-distributed applications involving computer command and control and computer-based monitoring, and any other area involving process, sequence or algorithm design. Hence, one skilled in the art will recognize that any number of other applications not listed can fall within the scope of this invention.

Some embodiments of the system 200 can provide mechanical or automatic generation of the script 214, in which human intervention is not required. In at least one embodiment of the system 200, all that may be required to update the generated application is a change in the scenarios 202, in which case the changes and validation can ripple through the entire system without human intervention when system 200 operates. This also allows the possibility of cost effectively developing competing designs for a product and implementing each to determine the best one.

Some embodiments of the system 200 may not include an automated logic engine, such as a theorem-prover or an automated deduction engine, to infer the script 214 from the scenarios 202. However, the script 214 can be a provably correct version of the scenarios 202.

Thus, in regards to scripts and complex procedures, automatic code generation of system 200 can generate procedures/scripts in suitable scripting language or device control language (such as for a robot) that would provide the procedures, once validated, to be automatically transformed into an implementation. Additionally, system 200 can be used to “reverse engineer” existing procedures/scripts so that the existing procedures/scripts can be analyzed and corrected and recast in a format and form that can be more easily understood. System 200 also can be used to reverse engineer multiple existing procedures/scripts (even written in different languages) to a single formal model by which the procedures/scripts are combined, analyzed for conflicts, and regenerated as a single procedure/script (in the same or a different procedure/scripting language).

Some embodiments of system 200 may operate in a multi-processing, multi-threaded operating environment on a computer, such as the computer 902 illustrated in FIG. 9. While the system 200 is not limited to any particular scenarios 202, inference engine 204, translator 206, formal specification 208, analyzer 210, script translator 212 and script 214, for sake of clarity, embodiments of simplified scenarios 202, inference engine 204, translator 206, formal specification 208, analyzer 210, script translator 212 and script 214 are illustrated.

In some embodiments, the system 200 may be a software development system that can include a data flow and processing points for the data. System 200 can be representative of (i) computer applications and electrical engineering applications such as chip design and other electrical circuit design, (ii) business management applications in areas such as workflow analysis, (iii) artificial intelligence applications in areas such as knowledge-based systems and agent-based systems, (iv) highly parallel and highly-distributed applications involving computer command and control and computer-based monitoring, and (v) any other area involving process, sequence or algorithm design. One skilled in the art, however, will recognize that other applications can exist that are within the purview of this invention. According to the disclosed embodiments, system 200 can, without human intervention, convert different types of specifications (such as natural language scenarios or descriptions which are effectively pre-processed scenarios) into process-based scripts on which model checking and other mathematics-based verifications are performed, and then optionally convert the script into code.

System 200 can be operational for a wide variety of languages for expressing requirements, thus system 200 may be generally applicable. Such applications may include, without limitation, distributed software systems, sensor networks, robot operation, complex scripts for spacecraft integration and testing, chemical plant operation and control, and autonomous systems. One skilled in the art will understand that these applications are cited by way of example and that other applications can fall within the scope of the invention.

According to some embodiments, a scenario can be a natural language text (or a combination of any, such as possibly graphical, representations of sequential steps or events) that describes the software's actions in response to incoming data and the internal goals of the software. Scenarios also can describe communication protocols between systems and between the components within the systems. Scenarios also can be known as use cases. A scenario can describe one or more potential executions of a system, such as describing what happens in a particular situation and what range of behaviors is expected from or omitted by the system under various conditions.

Natural language scenarios can be constructed in terms of individual scenarios written in a structured natural language. Different scenarios can be written by different stakeholders of the system, corresponding to the different views the stakeholders can have of how the system will perform, including alternative views corresponding to higher or lower levels of abstraction. Natural language scenarios can be generated by a user with or without mechanical or computer aid. Such a set of natural language scenarios can provide the descriptions of actions that occur as the software executes. Some of these actions can be explicit and required, while others can be due to errors arising or as a result of adapting to changing conditions as the system executes.

For example, if the system involves commanding space satellites, scenarios for that system can include sending commands to the satellites and processing data received in response to the commands. Natural language scenarios may be specific to the technology or application domain to which the natural language scenarios are applied. A fully automated general purpose approach covering all domains can be technically prohibitive to implement in a way that is both complete and consistent.

To ensure consistency, the domain of application can often be purpose-specific. For example, scenarios for satellite systems may not be applicable as scenarios for systems that manufacture agricultural chemicals.

### Method Embodiments

In the previous section, a system level overview of the operation of an embodiment is described. In this section, the particular methods of such an embodiment are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware may also be composed of computer-executable instructions. Methods 300-800 can be performed by a program executing on, or performed by firmware or hardware that is a part of, a computer, such as computer 902 in FIG. 9.

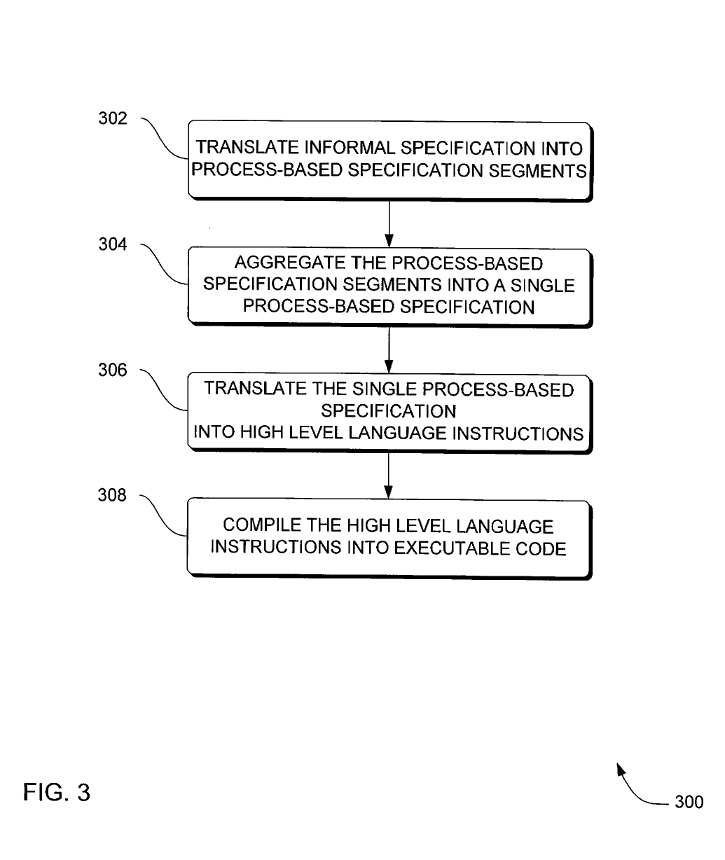

FIG. 3 is a flowchart of a method 300 to generate an executable system from an informal specification, according to an embodiment. Method 300 may solve the need in the art to generate executable computer instructions from requirements with neither the time involved in manually writing the executable computer instructions, nor the mistakes that may arise in manually writing the executable computer instructions, without using a theorem-prover.

Method 300 may include translating 302 mechanically each of a plurality of requirements of the informal specification to a plurality of process-based specification segments. In some embodiments, the translating 302 may include inferring the process-based specification segments from the informal specification. One embodiment of translating 302 is shown in FIG. 3 below.

In some embodiments, the process-based specification can be process algebra notation. That embodiment may satisfy the need in the art for an automated, mathematics-based process for requirements validation that does not require large computational facilities.

Thereafter, method 300 may include aggregating 304 the plurality of process-based specification segments into a single process-based specification model.

Subsequently, method 300 may include translating 306 the single process-based specification model to instructions encoded in the Java computer language or some other high-level computer programming language. Thereafter, method 300 may include compiling 308 the instructions encoded in the Java computer language into a file of executable instructions.

In some embodiments, method 300 may include invoking the executable instructions, which can provide a method to convert informal specifications to an application system without involvement from a computer programmer.

In some embodiments, method 300 may not include invoking a theorem-prover to infer the process-based specification segments from the informal specification.

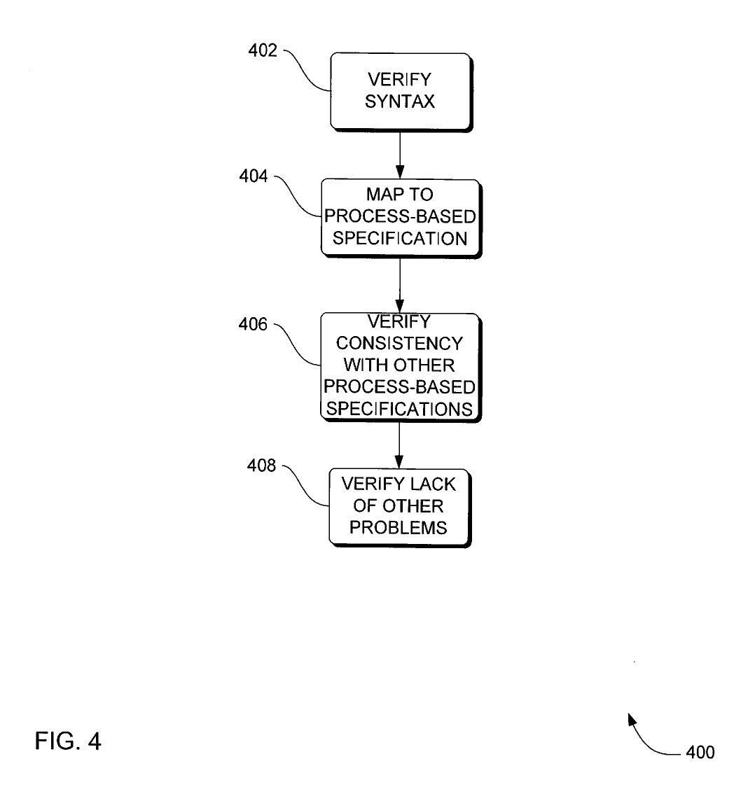

FIG. 4 is a flowchart of a method 400 to translate mechanically each of a plurality of requirements of the informal specification to a plurality of process-based specification segments, according to an embodiment. Method 400 may be one embodiment of translating 302 in FIG. 3.

Method 400 may include verifying 402 the syntax of the plurality of requirements of the informal specification. Thereafter, method 400 may include mapping 404 the plurality of requirements of the informal specification to a process-based specification.

In some embodiments, method 400 subsequently also may include verifying 406 consistency of the process-based specification with at least one other process-based specification. In some embodiments, method 400 subsequently also may include verifying 408 lack of other problems in the process-based specification. One example of other problems can be unreachable states in the process defined in the process-based specification.

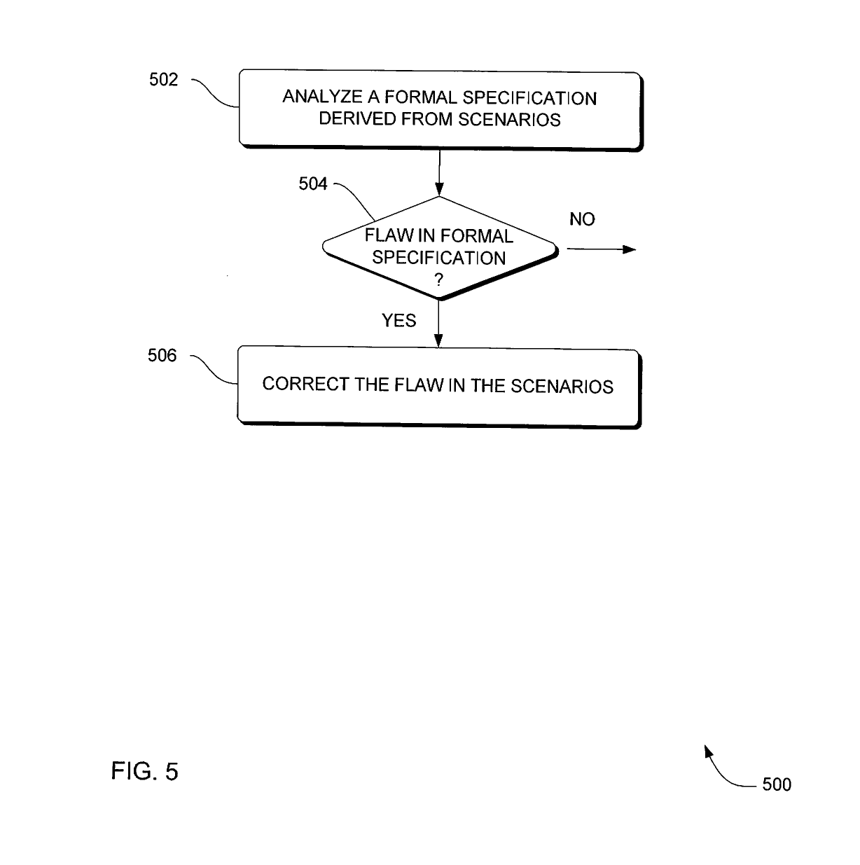

FIG. 5 is a flowchart of a method 500 to validate/update a system, according to an embodiment. Method 500 may solve the need in the prior art to reduce errors in scripts.

Method 500 can include analyzing 502 a script, such as script 214, of the system 200, the script having been previously derived from the rules of the system.

Thereafter, a determination 504 can be made as to whether or not the analyzing 502 indicates that the script contains a flaw. If a flaw does exist, then the rules can be corrected 506 accordingly.

In some embodiments, the analyzing 502 can include applying mathematical logic to the script in order to identify a presence or absence of mathematical properties of the script. Mathematical properties of the script that can be determined by applying mathematical logic to the script can include, by way of example:

1) whether or not the script implies a system execution trace that includes a deadlock condition.

2) whether or not the script implies a system execution trace that includes a livelock condition.

The above two properties can be domain independent. One skilled in the art will note that there are many other possible flaws that could be detected through the analysis of the model, many, or even most, of which might be domain dependent. An example of a domain dependent property would be represented by the operational principle that “closing a door that is not open is not a valid action.” This example would be applicable in the domain of the Hubble Space Telescope on-orbit repair.

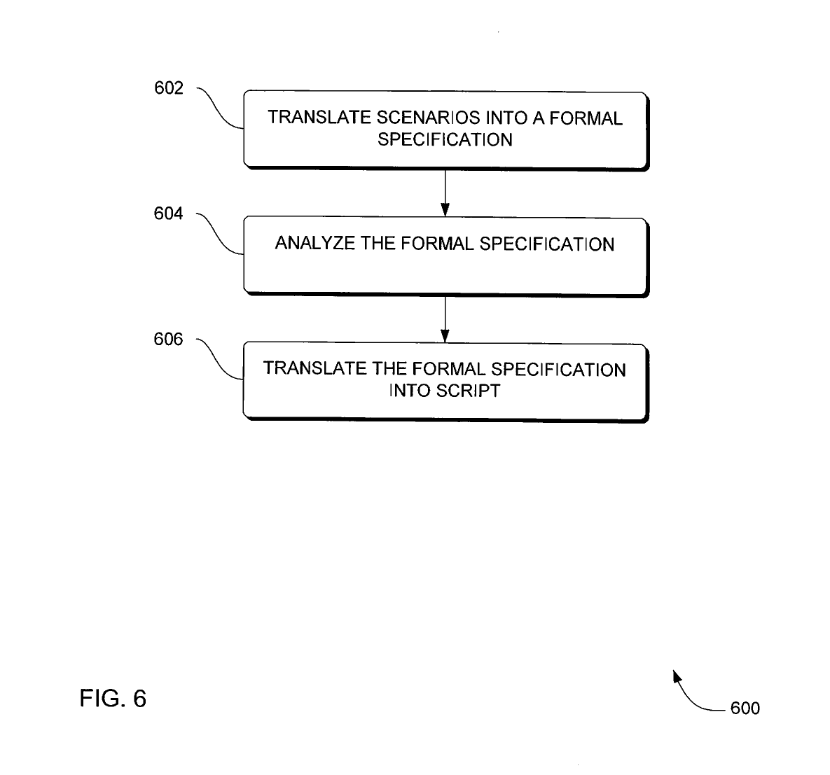

Because in some embodiments the script can be provably equivalent to the scenarios by virtue of method 500, if a flaw is detected in the script, then the flaw could be corrected by changing (correcting) the scenarios. Once the correction is made, then the corrected scenarios can be processed by system 200 in FIG. 2 or method 600 in FIG. 6 to derive a new script from the corrected scenarios. According to at least one embodiment, the new script can be processed by method 500, and the iterations of method 600 and method 500 can repeat until there are no more flaws in the script generated from the scenarios, at which point the scenarios have no flaws because the script is provably equivalent to the scenarios from which it was derived. Thus, iterations of methods 600 and 500 can provide verification/validation of the scenarios.

Thereafter, the new script can be used to generate an implementation of the system.

FIG. 6 is a flowchart of a method to validate/update scenarios of a system, according to an embodiment. The method 600 can include translating 602 scenarios 202 into a script 214 without human intervention.

Thereafter, method 600 can include optionally analyzing 604 the formal model or specification. The analyzing 604 can be a verification/validation of the scenarios 202. In some embodiments, the analyzing 604 can determine various properties such as existence of omissions, deadlock, livelock, and race conditions in the script 214, although one skilled in the art will know that analyzing the formal model can determine other properties not specifically listed, which are contemplated by this invention. In some embodiments, the analyzing 604 can provide a mathematically sound analysis of the scenarios 202 in a general format that doesn't require significant understanding of the specific rules of the scenarios 202. Further, the analyzing 604 can warn developers of errors in their scenarios 202, such as contradictions and inconsistencies, but equally importantly it can highlight rules or sets of rules that are underspecified or over-specified and need to be corrected for the scenarios 202 to operate as intended. Thus, no knowledge of the scenarios 202 may be required, but instead significant analysis, verification, testing, simulation and model checking of the scenarios 202 using customized tools or existing tools and techniques can be provided.

Thereafter, in some embodiments, method 600 can include translating 606 the formal specification to a script 214. Thus, in at least one embodiment, the method 600 can provide a method to convert scenarios to scripts without involvement from a computer programmer.

Most notably, some embodiments of the method 600 might not include invoking an automated logic engine, such as a theorem-prover, to infer the script 214 from the scenarios 202.

In method 600, informal representations of requirements for procedures/scripts that represent the operation of a system can be mechanically converted to a mathematically sound specification that can be analyzed for defects and used for various transformations including automatic translation into executable form and automatic regeneration of procedures/scripts into other notations/representations. In another embodiment, the method disclosed herein can be used to automatically reverse engineer existing procedures and scripts to formal models from which the method can be used to produce customer-readable representations of procedures/scripts or machine-processable scripts in any of various scripting languages.

Mathematically sound techniques can be used to mechanically translate an informal procedure/script requirement into an equivalent formal model. The model may be mechanically (that is, with no manual intervention) manipulated, examined, analyzed, verified, and used in a simulation.

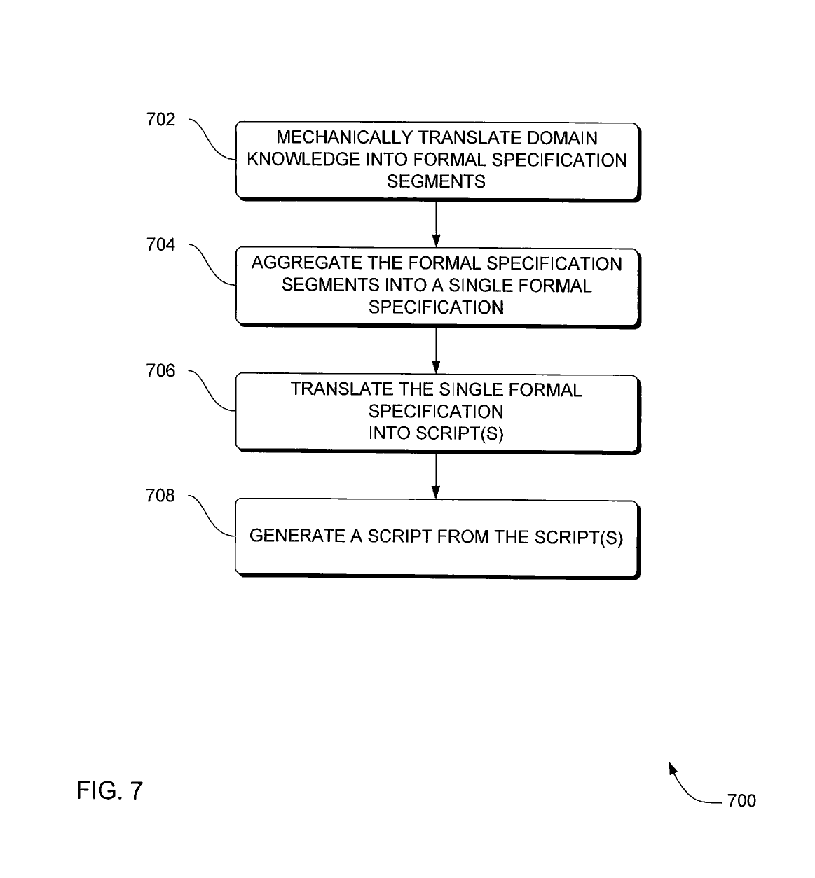

FIG. 7 is a flowchart of a method 700 to translate each of a plurality of requirements to a plurality of formal specification segments, and formally compose the plurality of formal specification segments into a single equivalent specification, and translate the single formal specification into a script, according to an embodiment. Method 700 can solve the need in the art to generate scripts from requirements with neither the time involved in manually writing the scripts, nor the mistakes that can arise in manually writing the scenarios, without using an automated logic engine.

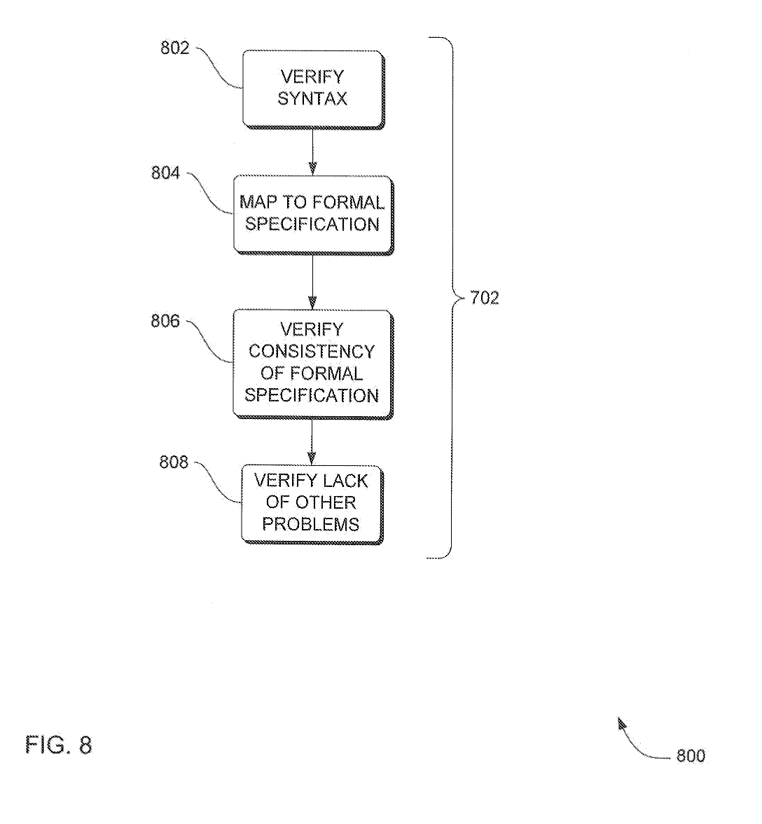

Method 700 can include mechanically translating 702 each of a plurality of scenarios to a plurality of formal specification segments. The translation can be done without human intervention. One embodiment of translating 702 is shown in FIG. 8 below.

Thereafter, method 700 can include aggregating 704 the plurality of formal specification segments into a single formal model.

Subsequently, method 700 can include translating 706 the single formal model to multiple scripts as output from translating 706. Thereafter, method 700 can include generating 708 a script from the scripts that were accepted from translating 706. Thus, method 700 can provide an embodiment of a method to convert a script to an application system without involvement from a computer programmer.

Most notably, some embodiments of method 700 may not include invoking a theorem-prover or any other automated logic engine to infer the formal specification segments from the scenarios.

FIG. 8 is a flowchart of a method 800 to verify the syntax of a set of scenarios, translate the set of scenarios to a formal specification, verify the consistency of the formal specification, and verify the absence of other problems, according to an embodiment. Method 800 might be an embodiment of translating 702 in FIG. 7. As indicated, such translation can be accomplished without human intervention.

In some embodiments, the method 800 can include verifying 802 the syntax of the plurality of scenarios. Thereafter, method 800 can include mapping 804 the plurality of scenarios to a specification.

In some embodiments, method 800 subsequently can also include verifying 806 consistency of the formal specification. In some embodiments, method 800 subsequently may also include verifying 808 a lack of other problems in the formal specification. One example of other problems may be unreachable states in the process defined in the formal specification, although one skilled in the art will understand that yet other problems are contemplated.

In some embodiments, methods 300-800 can be implemented as a computer data signal embodied in a carrier wave that represents a sequence of instructions, which, when executed by a processor, such as processor 904 in FIG. 9, cause the processor to perform the respective method. In other embodiments, methods 300-800 can be implemented as a computer-accessible medium having executable instructions capable of directing a processor, such as processor 904 in FIG. 9, to perform the respective method. In varying embodiments, the medium can be a magnetic medium, an electronic medium, an electromagnetic medium, a medium involving configurations or spatial positioning of electrons, ions, atoms, or molecules or aggregations of such particles, a medium involving quantum mechanical entities, or an optical medium. Other mediums will be readily apparent to one skilled in the art and fall within the scope of this invention.

### Hardware and Operating Environment

FIG. 9 is a block diagram of the hardware and operating environment 900 in which different embodiments can be practiced. The description of FIG. 9 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment. Some embodiments can also be at least partially implemented in a quantum mechanical computing and communications environment.

Computer 902 may include a processor 904, commercially available from Intel, Motorola, Cyrix and others. Computer 902 may also include random-access memory (RAM) 906, read-only memory (ROM) 908, and one or more mass storage devices 910, and a system bus 912, that operatively couples various system components to the processing unit 904. The memory 906, 908, and mass storage devices, 910, are types of computer-accessible media. Mass storage devices 910 are more specifically types of nonvolatile computer-accessible media and can include one or more hard disk drives, floppy disk drives, optical disk drives, and tape cartridge drives. The processor 904 can execute computer programs stored on the computer-accessible media.

Computer 902 can be communicatively connected to the Internet 914 (or any communications network) via a communication device 916. Internet 914 connectivity is well known within the art. In one embodiment, a communication device 916 may be a modem that responds to communication drivers to connect to the Internet via what is known in the art as a “dial-up connection.” In another embodiment, a communication device 916 may be an Ethernetg or similar hardware network card connected to a local-area network (LAN) that itself is connected to the Internet via what is known in the art as a “direct connection” (e.g., T1 line, etc.).

A user may enter commands and information into the computer 902 through input devices such as a keyboard 918 or a pointing device 920. The keyboard 918 permits entry of textual information into computer 902, as known within the art, and embodiments are not limited to any particular type of keyboard. Pointing device 920 permits the control of the screen pointer provided by a graphical user interface (GUI) of operating systems such as versions of Microsoft Windows®. Embodiments are not limited to any particular pointing device 920. Such pointing devices may include mice, touch pads, trackballs, remote controls and point sticks. Other input devices (not shown) can include a microphone, joystick, game pad, gesture-recognition or expression recognition devices, or the like.

In some embodiments, computer 902 may be operatively coupled to a display device 922. Display device 922 can be connected to the system bus 912. Display device 922 can permit the display of information, including computer, video and other information, for viewing by a user of the computer. Embodiments are not limited to any particular display device 922. Such display devices may include cathode ray tube (CRT) displays (monitors), as well as flat panel displays such as liquid crystal displays (LCD's) or image and/or text projection systems or even holographic image generation devices. In addition to a monitor, computers typically may include other peripheral input/output devices such as printers (not shown). Speakers 924 and 926 (or other audio device) can provide audio output of signals. Speakers 924 and 926 can also be connected to the system bus 912.

Computer 902 may also include an operating system (not shown) that may be stored on the computer-accessible media RAM 906, ROM 908, and mass storage device 910, and can be executed by the processor 904. Examples of operating systems include Microsoft Windows®, Apple MacOS®, Linux®, UNIXg®. Examples are not limited to any particular operating system, however, and the construction and use of such operating systems are well known within the art.

Embodiments of computer 902 are not limited to any type of computer 902. In varying embodiments, computer 902 may comprise a PC-compatible computer, a MacOS®-compatible computer, a Linux®-compatible computer, or a UNIX®-compatible computer. The construction and operation of such computers are well known within the art.

Computer 902 can be operated using at least one operating system to provide a graphical user interface (GUI) including a user-controllable pointer. Computer 902 can have at least one web browser application program executing within at least one operating system, to permit users of computer 902 to access an intranet, extranet or Internet world-wide-web pages as addressed by Universal Resource Locator (URL) addresses. Examples of browser application programs include Netscape Navigator® and Microsoft Internet Explorer®.

The computer 902 can operate in a networked environment using logical connections to one or more remote computers, such as remote computer 928. These logical connections can be achieved by a communication device coupled to, or a part of, the computer 902. Embodiments are not limited to a particular type of communications device. The remote computer 928 can be another computer, a server, a router, a network PC, a client, a peer device or other common network node. The logical connections depicted in FIG. 9 include a local-area network (LAN) 930 and a wide-area network (WAN) 932. Such networking environments are commonplace in offices, enterprise-wide computer networks, intranets, extranets and the Internet.

When used in a LAN-networking environment, the computer 902 and remote computer 928 can be connected to the local network 930 through network interfaces or adapters 934, which is one type of communications device 916. Remote computer 928 may also include a network device 936. When used in a conventional WAN-networking environment, the computer 902 and remote computer 928 can communicate with a WAN 932 through modems (not shown). The modem, which can be internal or external, may be connected to the system bus 912. In a networked environment, program modules depicted relative to the computer 902, or portions thereof, can be stored in the remote computer 928.

Computer 902 also includes power supply 938. Each power supply can be a battery.

### CSP Implementation

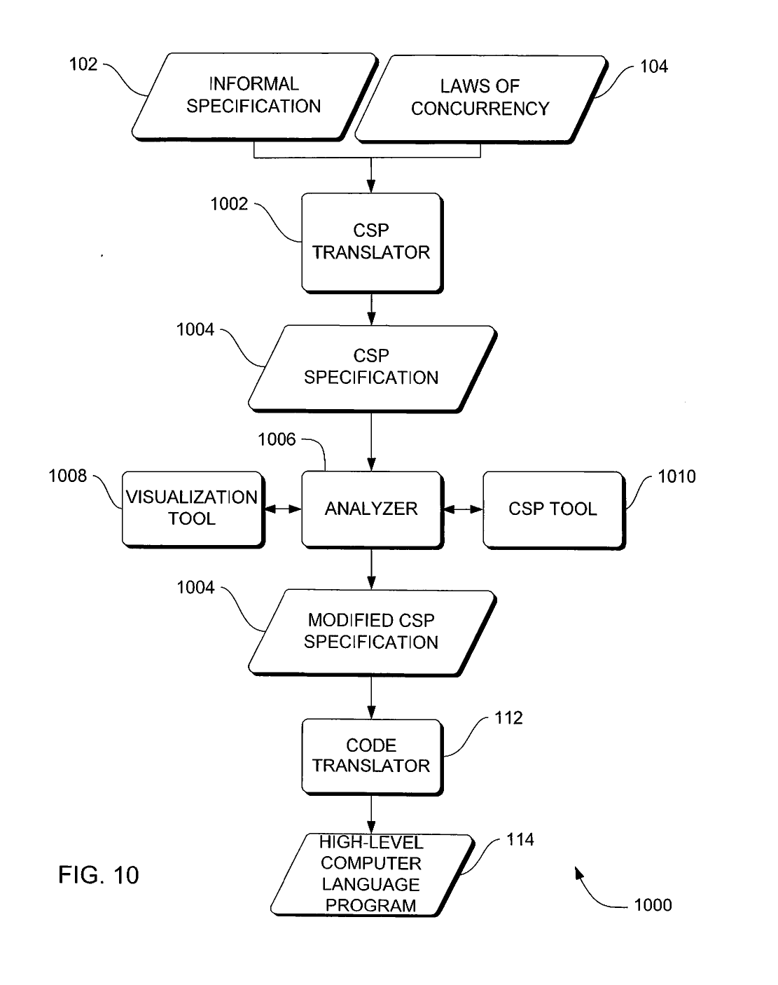

Referring to FIG. 10, a particular CSP implementation 1000 is described in conjunction with the system overview in FIG. 1 and the methods described in conjunction with FIG. 3 and FIG. 4.

FIG. 10 is a block diagram of a particular CSP implementation of an apparatus 1000 to generate a high-level computer source code program from an informal specification, according to an embodiment. Apparatus 1000 may solve the need in the art for an automated, generally applicable way to produce a system that is a provably correct implementation of an informal design specification that does not require use of a theorem-prover.

Apparatus 1000 may include an informal specification 102 having a plurality of rules or requirements. The informal specification 102 can be expressed in restricted natural language, graphical notations, or even using semi-formal notations such as unified modeling language (UML) use cases. One skilled in the art will recognize that any number of languages and notations may be used that fall within the purview of this invention. Apparatus 1000 may also include a set of laws of concurrency 104.

The informal specification 102 and a set of laws of concurrency 104 may be received by a mechanical CSP translator 1002. The plurality of rules or requirements of the informal specification 102 can be translated mechanically to a specification 1004 encoded in Hoare's language of Communicating Sequential Processes (CSP). In some embodiments, the mechanical CSP translator 1002 can perform actions 302 and 304 in FIG. 3.

In some embodiments, the system may include a formal specification analyzer 1006 to perform model verification/checking and determine existence of omissions, deadlock, livelock and race conditions in the CSP specification 1004. In some embodiments, the formal specification analyzer 1006 can receive and transmit information from and to a visualization tool 1008 that can provide a way to modify the CSP specification 1004. In some embodiments, the formal specification analyzer 1006 can receive and transmit information from and to a tool 1010 designed for CSP that provides a way to modify the CSP specification 1004.

The formal specification analyzer 1006 may generate a modified CSP specification 1004 that may in turn be received by a code translator 112 or compiler to translate the plurality of process-based specification segments 108 to a set of instructions in a high-level computer language program 114, such as Java language.

Formal specification analyzer 1006 may allow the user to manipulate the formal specification 1004 in various ways. The formal specification analyzer 1006 may allow the user to examine the system described by the informal specification 102, and to manipulate it. The CSP specification 1004 may be analyzed to highlight undesirable behavior, such as race conditions, and equally important, to point out errors of omission in the informal specification 102. The formal specification analyzer 1006 can be an optional but useful stage in the disclosed embodiments of the present invention. If the formal specification analyzer 1006 is not used, then the process-based specification 160 and the modified CSP specification 1004 may be identical. Hence, if the formal specification analyzer 1006 is not used, then all references to the modified CSP specification 1004 disclosed below may also apply to the CSP specification 1004.

Most notably, some embodiments of apparatus 1000 may not include a theorem-prover to infer the process-based specification segments from the informal specification.

Apparatus 1000 can be operational for a wide variety of informal specification languages and applications, and thus apparatus 1000 may be generally applicable. Such applications may include distributed software systems, sensor networks, robot operation, complex scripts for spacecraft integration and testing, and autonomous systems. Those skilled in the art will know that other applications fall within the scope of this invention.

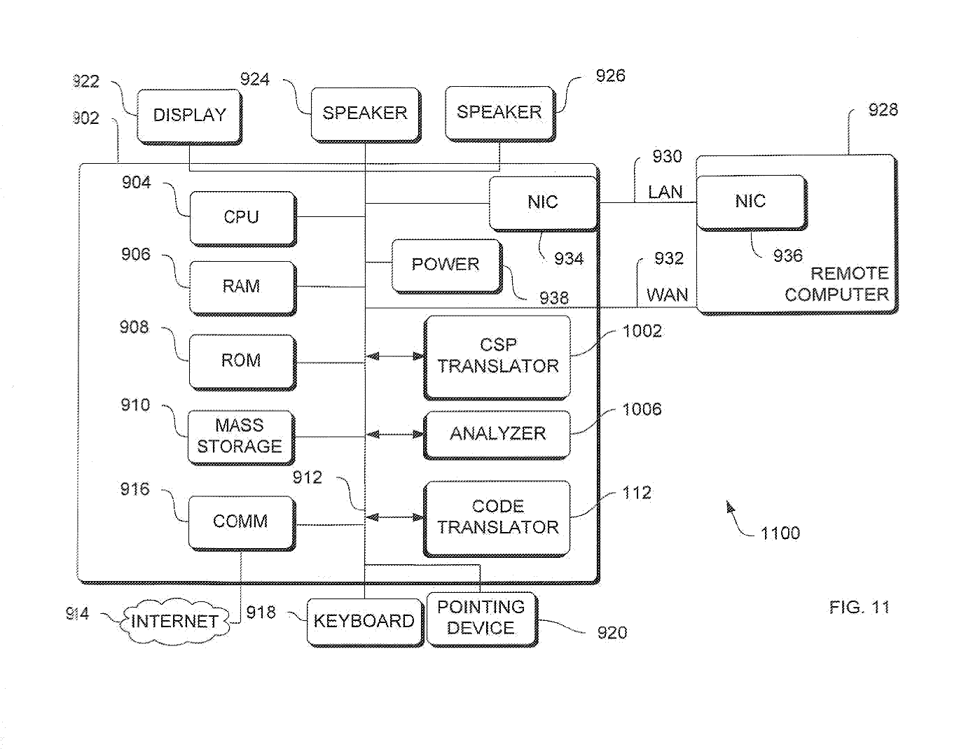

Apparatus 1000 components of the mechanical CSP translator 1002, the formal specification analyzer 1006, and the code translator 112 can be embodied as computer hardware circuitry or as a computer-readable program, or a combination of both, such as shown in FIG. 11. In another embodiment, apparatus 1000 can be implemented in an application service provider (ASP) system.

FIG. 11 is a block diagram of a hardware and operating environment in which a particular CSP implementation of FIG. 10 is implemented, according to an embodiment.

### Script Implementation

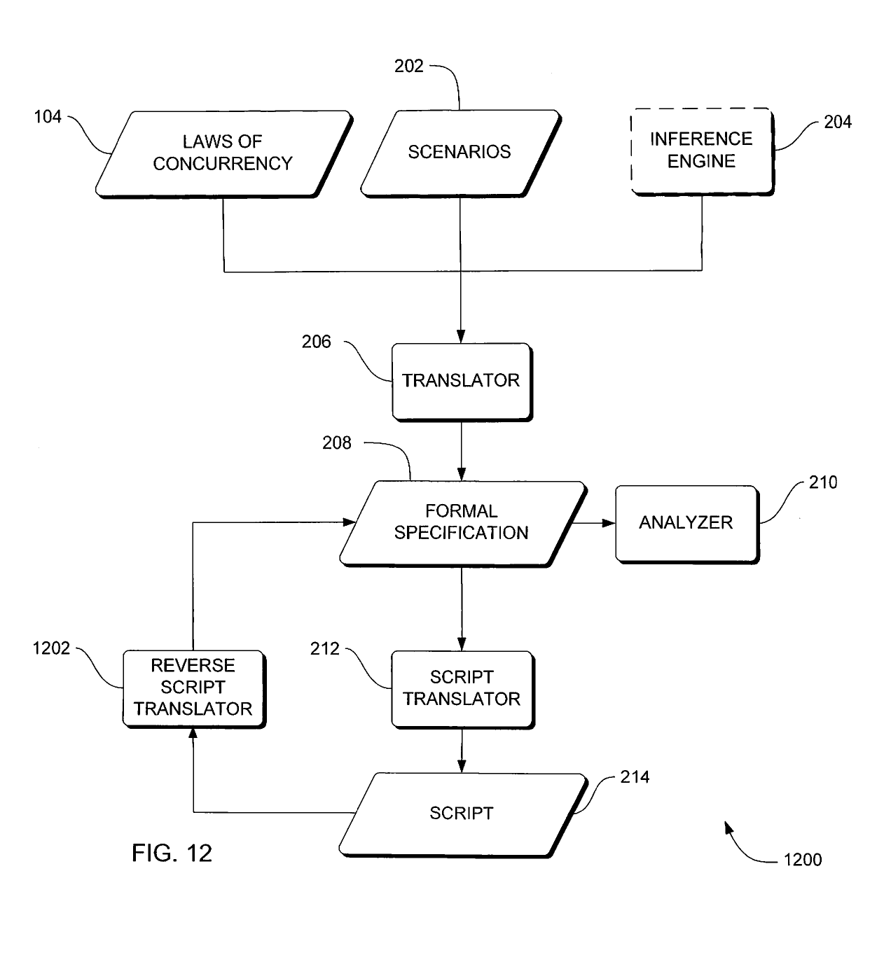

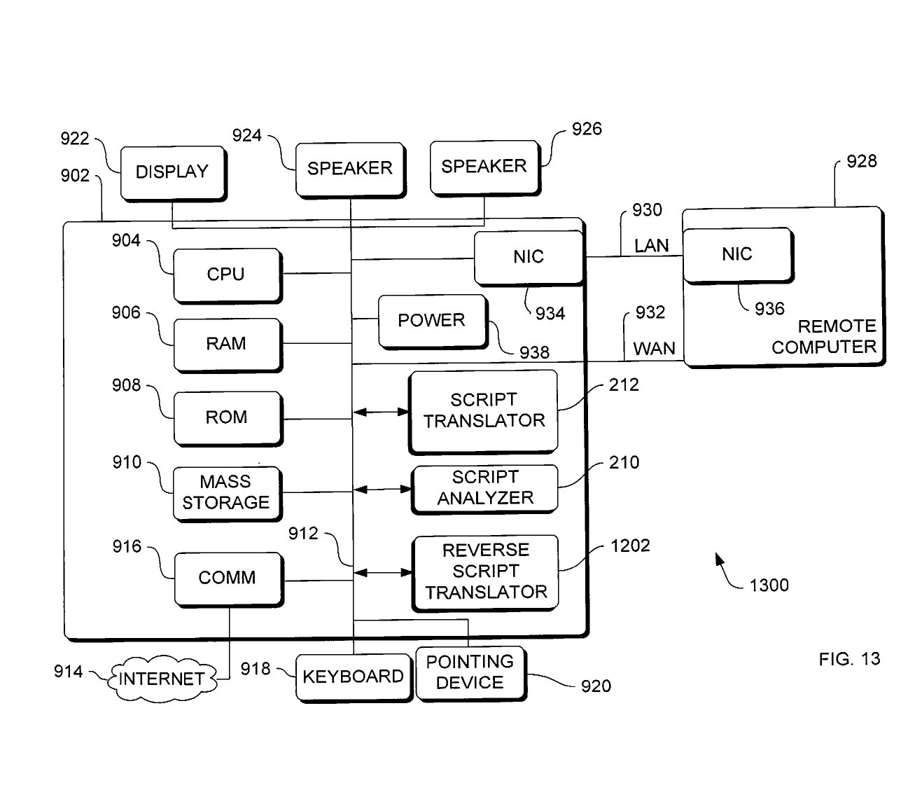

Referring to FIGS. 12 and 13, a particular scripting language implementation 1200 is described in conjunction with the system overview in FIG. 2 and the methods described in conjunction with FIGS. 3-8.

FIG. 12 is a block diagram of a particular implementation of an apparatus capable of translating scenarios to a formal specification, optionally analyzing the formal specification and translating the formal specification to a script and reverse engineering (translating) a script into a formal specification (and possibly analyzing the formal specification), according to an embodiment. Apparatus 1200 may solve the need in the art for an automated, generally applicable way to verify that implemented scripts are a provably correct implementation of a scenario(s).

Apparatus 1200 can include a translator 206 that generates a formal specification 208 from the laws of concurrency 104 and the scenario(s) 202 in reference to the optional inference engine 204.

Subsequently, the formal specification 208 may be translated by script translator 212 into a script 214 in some appropriate scripting language. In some embodiments, no manual intervention in the translation may be provided. Those skilled in the art will readily understand that other appropriate notations and/or languages exist that are within the scope of this invention.

In some embodiments, apparatus 1200 can include an analyzer 210 to determine various properties of the formal specification, such as the existence of omissions, deadlock, livelock, and race conditions, as well as other conditions, in the formal specification 208, although one skilled in the art will recognize that other additional properties can be determined by the analyzer 210. The analyzer 210 may solve the need in the prior art to reduce errors.

In some embodiments, a reverse script translator 1202 can receive the script 214 and generates a formal specification. In various embodiments, the output of the reverse script translator 1202 is a different formal specification than formal specification 208 received from translator 206. While there can be some small differences between the formal specification generated by reverse script translator 1202 and formal specification 208, the formal specifications generated by the reverse script translator 1202 can be substantially functionally equivalent to the formal specification 208.

Apparatus 1200 can operate for a wide variety of languages and applications, and thus apparatus 1200 may be generally applicable. Such applications can include, without limitation, distributed software systems, sensor networks, robot operation, complex scripts for spacecraft integration and testing, and autonomous systems, but those skilled in the art will understand that other applications are contemplated.

Apparatus 1200 components such as the script translator 212, the script analyzer 210, and the reverse script translator 1202 can be embodied as computer hardware circuitry or as a computer-readable program, or a combination of both, such as shown in FIG. 13. In another embodiment, apparatus 1200 can be implemented in an application service provider (ASP) system.

FIG. 13 illustrates an environment 1300 similar to that of FIG. 9, but with the addition of the script translator 212, the analyzer 210 and the reverse script translator 1202 that correspond to some of apparatus 1200.

In a computer-readable program embodiment, the programs can be structured in an object-orientation using an object-oriented language such as Java, Smalltalk or C++, and the programs can be structured in a procedural-orientation using a procedural language such as COBOL or C. The software components may communicate in any of a number of ways that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components can execute on as few as one computer as in computer 902 in FIG. 9, or on at least as many computers as there are components.

### Conclusion

Systems, methods and apparatus described herein may have many commercial applications, as follows: (1) Business procedures, in a variety of domains, may be analyzed, evaluated, improved, combined, verified, and automatically implemented in a programming language. (2) Formal modes may have been proposed for analyzing legal contracts. However, legal experts may not be likely to have the required skills to develop such mathematical models. This approach may enable legal contracts to be converted automatically to a formal model and analyzed. (3) Procedures for assembling (or dissembling) components in a factory, in space, or elsewhere, whether performed by robots or humans, are prone to error and “trial and error.” The approach disclosed herein may eliminate the uncertainty and ensure that procedures are correct. (4) There are a large number of scripts in the public domain, in particular in communications networks and the bioinformatics industry. Similarly, NASA (and other organizations) have many existing scripts used for space mission test and integration. Most of these scripts have little or no documentation, meaning that the script cannot be used except by explanations of the working of the scripts, and hence their reuse. (5) Existing scripts can be combined using this approach, and can be checked for incompatibilities, etc. Then a single script may be generated to combine the functionality of several scripts. This may have major ramifications for bioinformatics, robotic assembly and maintenance, integration and test, and other domains.

Systems and methods for generating scripts from requirements expressed as scenarios are described according to an embodiment. In some embodiments, the systems and methods also allow for “reverse engineering,” analysis, and correction of errors found in existing scripts. In some embodiments, the methods allow multiple existing scripts to be combined, discrepancies resolved and re-generated as a single script in which confidence can be placed in its correct implementation of the stated requirements (which can be “captured” from the existing implementation).

Although specific embodiments have been illustrated and described herein, it will be appreciated by those of ordinary skill in the art that any arrangement which is calculated to achieve the same purpose can be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In some embodiments, a formal model may be generated from the scenarios. The formal model may then be analyzed for a range of different possible errors in the scenarios. Additionally, scripts may be generated that correspond to the scenarios. Since the scripts can be generated automatically, there may be a significantly reduced likelihood of error, and common “programming” errors may be eliminated. These scripts may be in a scripting language such as PERL, BioPerl, PYTHON, etc. or in a language suitable for controlling machines, robots and other devices.

Existing scripts can be combined, analyzed, and regenerated as a single script in the same language, or another language, that increases accuracy and reduces common errors.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all object-oriented, database and communication environments and alternate technologies which provide the same functionality as described herein.

We claim:

1. A computer-accessible medium having executable instructions to validate a system, the executable instructions capable of directing a processor to perform:
receiving scenarios of the system; and
translating the scenarios of the system to at least one script.

2. The computer-accessible medium of claim 1, wherein the executable instructions further comprise:
translating the scenarios of the system to a script, without the use of an automated inference engine.

3. The computer-accessible medium of claim 1, wherein the executable instructions further comprise:
translating the scenarios of the system to a script, in reference to an inference engine.

4. The computer-accessible medium of claim 1, wherein the executable instructions further comprise:
translating the scenarios of the system to a formal specification, in reference to an inference engine; and
translating the formal specification to the script.

5. The computer-accessible medium of claim 1, the medium further comprising executable instructions capable of directing the processor to perform:
analyzing the formal specification.

6. The computer-accessible medium of claim 5, wherein the executable instructions capable of directing the processor to perform analyzing the formal specification further comprises:
applying mathematical logic to the formal specification in order to identify a presence or absence of mathematical properties of the scenario.

7. The computer-accessible medium of claim 6, the medium further comprising executable instructions capable of directing the processor to perform:
correcting the absence of the mathematical properties if the mathematical properties are identified as absent in the scenario.

8. The computer-accessible medium of claim 6, wherein the mathematical properties of the script further comprise:
whether the script implies a system execution trace that includes a deadlock condition;
whether the script implies a system execution trace that includes a livelock condition; and
whether the script implies a system execution trace that exhibits or does not exhibit a plurality of other desirable or undesirable behaviors including but not limited to safety properties, security properties, unreachable states, inconsistencies, naming conflicts, unused variables, unexecuted code.

9. The computer-accessible medium of claim 1, wherein the script further comprises:
a script encoded in PERL language.

10. The computer-accessible medium of claim 1, wherein the script further comprises:
a script encoded in BIOPERL language.

11. The computer-accessible medium of claim 1, wherein the script further comprises:
a script encoded in PYTHON language.

12. The computer-accessible medium of claim 1, wherein the script further comprises:
a script encoded in AWK language.

13. The computer-accessible medium of claim 1, the medium further comprising executable instructions capable of directing the processor to perform:
translating the script to a formal model, and
translating the formal model to scenarios.

14. A computer-accessible medium having executable instructions to generate a system from scenarios, the executable instructions capable of directing a processor to perform:
translating scenarios to a formal specification; and
translating the formal specification to at least one script implementing the system.

15. The computer-accessible medium of claim 14, wherein the executable instructions further comprise:
verifying the syntax of the scenarios; and
mapping the scenarios to a plurality of formal specification segments.

16. The computer-accessible medium of claim 14, wherein the executable instructions further comprise:
verifying consistency of the formal specification.

17. The computer-accessible medium of claim 14, the medium further comprising executable instructions capable of directing the processor to perform:
analyzing the formal specification.

18. The computer-accessible medium of claim 14, the medium further comprising executable instructions capable of directing the processor to perform:
determining mathematical and logical properties of the formal specification by an automated inference engine.

19. The computer-accessible medium of claim 14, wherein the executable instructions further comprise:
translating the scenarios to a separate formal specification without the use of an automated inference engine.

20. The computer-accessible medium of claim 14, wherein the at least one script further comprises:
a script encoded in PERL language.

21. The computer-accessible medium of claim 14, wherein the at least one script further comprises:
a script encoded in AWK language.

22. The computer-accessible medium of claim 14, wherein the at least one script further comprises:
a script encoded in PYTHON language.

23. The computer-accessible medium of claim 14, wherein the system further comprises:
a script.

24. A system to validate a software system, the system comprising:
an inference engine;
a translator, operable to receive a plurality of scenarios of the software system and to generate in reference to the inference engine a specification encoded in a formal specification language; and
an analyzer, operable to perform model verification/checking and determine existence of omissions, deadlock, livelock, and race conditions or other problems and inconsistencies in the formal specification.

25. The system of claim 24, wherein the software apparatus further comprises:
an analyzer operable to perform model verification/checking and determine existence of omissions, deadlock, livelock, and race conditions in the script.

26. The system of claim 24, wherein the translation of the scenarios into a script is carried out without human intervention.

27. A computer-accessible medium having executable instructions to validate a system, the executable instructions capable of directing a processor to perform:
receiving scenarios of the system;
translating the scenarios of the system to a formal specification; and
translating the formal specification to a script.

28. The computer-accessible medium of claim 27, wherein the executable instructions further comprise:
translating the scenarios of the system to a formal specification, without the use of an automated inference engine.

29. The computer-accessible medium of claim 27, wherein the executable instructions further comprise:
translating the scenarios of the system to a formal specification, in reference to an inference engine.

30. The computer-accessible medium of claim 27, wherein the medium further comprises executable instructions capable of directing the processor to perform:
analyzing the formal specification.

31. The computer-accessible medium of claim 30, wherein the executable instructions capable of directing the processor to perform analyzing the formal specification further comprise:
applying mathematical logic to the formal specification in order to identify a presence or absence of mathematical properties of the formal specification.

32. The computer-accessible medium of claim 31, wherein the mathematical properties of the formal specification further comprise:
whether the formal specification implies a system execution trace that includes a deadlock condition;
whether the formal specification implies a system execution trace that includes a livelock condition; and
whether the formal specification implies a system execution trace that exhibits or does not exhibit a plurality of other desirable or undesirable behaviors including safety properties, security properties, unreachable states, inconsistencies, naming conflicts, unused variables, and unexecuted code.

33. The computer-accessible medium of claim 27, wherein the script further comprises: a script encoded in PERL language.

34. The computer-accessible medium of claim 27, wherein the script further comprises:
a script encoded in BIOPERL language.

35. The computer-accessible medium of claim 27, wherein the script further comprises:
a script encoded in PYTHON language.

36. The computer-accessible medium of claim 27, wherein the script further comprises:
a script encoded in AWK language.

37. The computer-accessible medium of claim 27, the medium further comprising executable instructions capable of directing the processor to perform:
translating the script to a formal model; and
translating the formal model to at least one scenario.

38. A computer-accessible medium having executable instructions to validate a system, the executable instructions capable of directing a processor to perform:
receiving a formal model of the system; and
translating the formal model to at least one script.

39. The computer-accessible medium of claim 38, the medium further comprising executable instructions capable of directing the processor to perform:
analyzing the formal model.

40. The computer-accessible medium of claim 39, wherein the executable instructions further comprise:
applying mathematical logic to the formal model in order to identify a presence or absence of mathematical properties of the script.

41. The computer-accessible medium of claim 40, wherein the mathematical properties of the script further comprise:
whether the formal model implies a system execution trace that includes a deadlock condition;
whether the formal model implies a system execution trace that includes a livelock condition; and
whether the formal model implies a system execution trace that exhibits or does not exhibit a plurality of other desirable or undesirable behaviors including safety properties, security properties, unreachable states, inconsistencies, naming conflicts, unused variables, and unexecuted code.

42. The computer-accessible medium of claim 38, the medium further comprising executable instructions capable of directing the processor to perform:
translating the formal model to at least one scenario.

43. The computer-accessible medium of claim 38, wherein the script further comprises:
a script encoded in PERL language.

44. The computer-accessible medium of claim 38, wherein the script further comprises:
a script encoded in BIOPERL language.

45. The computer-accessible medium of claim 38, wherein the script further comprises:
a script encoded in PYTHON language.

46. The computer-accessible medium of claim 38, wherein the script further comprises:
a script encoded in AWK language.

47. A computer-accessible medium having executable instructions to validate a system, the executable instructions capable of directing a processor to perform:
receiving a script of the system; and
translating the script to a formal model.

48. The computer-accessible medium of claim 47, the medium further comprising executable instructions capable of directing the processor to perform:
analyzing the formal model.

49. The computer-accessible medium of claim 48, wherein the executable instructions further comprise:
applying mathematical logic to the formal model in order to identify a presence or absence of mathematical properties of the script.

50. The computer-accessible medium of claim 49, wherein the mathematical properties of the script further comprise:
whether the formal model implies a system execution trace that includes a deadlock condition;
whether the formal model implies a system execution trace that includes a livelock condition; and
whether the formal model implies a system execution trace that exhibits or does not exhibit a plurality of other desirable or undesirable behaviors including safety properties, security properties, unreachable states, inconsistencies, naming conflicts, unused variables, and unexecuted code.

51. The computer-accessible medium of claim 47, wherein the script further comprises:
a script encoded in PERL language.

52. The computer-accessible medium of claim 47, wherein the script further comprises:
a script encoded in BIOPERL language.

53. The computer-accessible medium of claim 47, wherein the script further comprises:
a script encoded in PYTHON language.

54. The computer-accessible medium of claim 47, wherein the script further comprises:
a script encoded in AWK language.

55. A computer-accessible medium having executable instructions to validate a system, the executable instructions capable of directing a processor to perform:
receiving a formal model of the system; and
translating the formal model to at least one scenario.

56. The computer-accessible medium of claim 55, the medium further comprising executable instructions capable of directing the processor to perform:
analyzing the formal model.

57. The computer-accessible medium of claim 56, wherein the executable instructions further comprise:
applying mathematical logic to the formal model in order to identify a presence or absence of mathematical properties of the script.

58. The computer-accessible medium of claim 57, wherein the mathematical properties of the script further comprise:
whether the formal model implies a system execution trace that includes a deadlock condition;
whether the formal model implies a system execution trace that includes a livelock condition; and
whether the formal model implies a system execution trace that exhibits or does not exhibit a plurality of other desirable or undesirable behaviors including safety properties, security properties, unreachable states, inconsistencies, naming conflicts, unused variables, and unexecuted code.

59. A computer-accessible medium having executable instructions to validate a system, the executable instructions capable of directing a processor to perform:
translating a plurality of scripts to a plurality of formal models;
combining the plurality of formal models to a singular formal model;
analyzing the singular formal model;
correcting any absence of mathematical properties in the singular formal model; and
translating the singular formal model to a scenario.

60. The computer-accessible medium of claim 59, wherein the executable instructions further comprise:
applying mathematical logic to the singular formal model in order to identify a presence or absence of mathematical properties of the singular formal model.

61. The computer-accessible medium of claim 60, wherein the mathematical properties of the singular formal model further comprise:
whether the singular formal model implies a system execution trace that includes a deadlock condition;
whether the singular formal model implies a system execution trace that includes a livelock condition; and
whether the singular formal model implies a system execution trace that exhibits or does not exhibit a plurality of other desirable or undesirable behaviors including safety properties, security properties, unreachable states, inconsistencies, naming conflicts, unused variables, and unexecuted code.
